(19) United States
(12) Patent Application Publication
(10) Pub. No.: US 2003/0162541 A1
(43) Pub. Date: Aug. 28, 2003

(54) Method for supporting a number of checksum algorithms in a network node

(76) Inventors: Hans Juergen Schwarzbauer, Grobenzell (DE); Michael Tuexen, Munchen (DE)

Correspondence Address: MORRISON & FOERSTER LLP, 1650 TYSONS BOULEVARD, SUITE 300, MCLEAN, VA, 22102, US

(21) Appl. No.: 10/343,153

(22) PCT Filed: May 6, 2002
(86) PCT No.: PCT/DE02/01626

(30) Foreign Application Priority Data
Jul. 30, 2001 (DE) 101372183

(51) Int. Cl. H04Q 7/20

(52) U.S. Cl. 455/432; 455/445

(57) ABSTRACT

Method to support a plurality of checksum algorithms in a first network node (A), according to which a communication relationship is established between the first network node (A) and a second network node (B), the initialization of which is effected by the first network node (A) in that in a first step a first checksum algorithm is selected by the first network node (A), in a second step the selected checksum algorithm is signaled to the second d network node (B) by the first network node (A), in a third step the communication relationship is established using the selected checksum algorithm if the initialization of the communication relationship by means of the selected checksum algorithm is accepted by the second network node (B) or in the third step a further checksum algorithm is selected by the first network node (A) if the initialization of the communication relationship by means of the selected checksum algorithm is rejected or ignored by the second network node (B), the second and third step then being repeated using the newly selected checksum algorithm.

Consideration is given to connection-oriented communication protocols in which each packet contains a checksum. The algorithm used to form the checksum is not relevant here. However, if this algorithm is changed and replaced by one or more new algorithms, it is likely during a transitional period that both the old and the new algorithm will be used within a communication network. Furthermore, as a packet with an incorrect checksum is normally discarded by the receiver, it is necessary to specify for each communication relationship which algorithm will be used to form the checksum.

Previously, the algorithm which was to be used to form the checksum was either prescribed on a network-wide basis or specified for each communication relationship by the network operator. The first solution is not acceptable in a transitional phase, however. The second solution requires additional development overhead on the part of the manufacturer of the switching systems or network nodes for administration of the selection of the algorithm for forming the checksum on the one hand; on the other hand, however, the network operator must make and configure this selection for each communication relationship. This can be a very time-consuming and cost-intensive process and is extremely error-prone.

The object underlying the present invention consists in specifying a method to support a plurality of checksum algorithms in a network node that avoids the disadvantages of the prior art.

This object is achieved by a method to support a plurality of checksum algorithms in a network node according to the features of claims 1 or 2.

Preferred embodiments are stated in the dependent claims.

According to the present invention, a method to support a plurality of checksum algorithms is provided in a first network node A, according to which a communication relationship is established between the first network node A and a second network node B, the initialization of which is effected by the first network node A, in that

in a first step, a first checksum algorithm is selected by the first network node A,

in a second step, the selected checksum algorithm is signaled to the second network node B by the first network node A,

in a third step, the communication relationship is established using the selected checksum algorithm if the initialization of the communication relationship using the selected checksum algorithm is accepted by the second network node B or

in the third step, a further checksum algorithm is selected by the first network node A if the initialization of the communication relationship using the selected checksum algorithm is rejected or ignored by the second network node B, the second and third steps then being repeated using the newly selected checksum algorithm.

According to the present invention, a method to support a plurality of checksum algorithms is also provided in a first network node (A) for an existing communication relationship between the first network node (A) and a second network node (B), for which a first checksum algorithm is used, according to which

in a first step, a second checksum algorithm is selected by the first network node (A),

in a second step, the selected checksum algorithm is signaled to the second network node (B) by the first network node (A),

in a third step, the selected checksum algorithm is specified for the communication relationship if the use of the selected checksum algorithm is accepted by the second network node (B) or

in the third step, a further checksum algorithm is selected by the first network node (A) if the selected checksum algorithm is rejected or ignored by the second network node (B), the second and third steps then being repeated using the newly selected checksum algorithm.

It is especially advantageous for the first network node A to signal the selected checksum algorithm to the second network node B indirectly, by sending an initialization message which is coded by means of the checksum algorithm to be signaled claim 5.

An important advantage of the method according to the invention resides in the fact that the administrative configuration or the administrative specification of the checksum algorithm is dispensed with. This removes, for example, the aforementioned disadvantages for the network operator when introducing a new algorithm for forming the checksum. The manufacturer of the switching centers or network nodes implements a method which permits all the implemented algorithms to be used transparently. The development overhead in this case is not greater than for providing the option of administration.

It can be advantageous here for an endpoint or network node which uses the method according to the invention to communicate with other endpoints or network nodes which either also use the method according to the invention or only use the old checksum algorithm or only use the new checksum algorithm.

Both communication partners or network nodes use the same algorithm for forming the checksum for a connection in both directions. This entails the active endpoint or network node selecting a checksum algorithm and starting the normal connection setup procedure. Once selected, the checksum algorithm for a connection with a specific communication partner or network node is also used for reception of packets or messages from this partner or network node. With received messages or packets which represent a connection request for a previously unknown connection, the passive endpoint or network node uses all the checksum algorithms known to it to check whether the message or packet has been transferred correctly. If this check was successful with only one checksum, the corresponding checksum algorithm is selected for this connection.

If the connection request is not answered even after possibly several repetitions, the active endpoint or network node waits for a specific randomly determined length of time and then starts the connection request over again, but using a different checksum algorithm.

The method according to the invention is explained in greater detail below in connection with four drawings as an embodiment example.

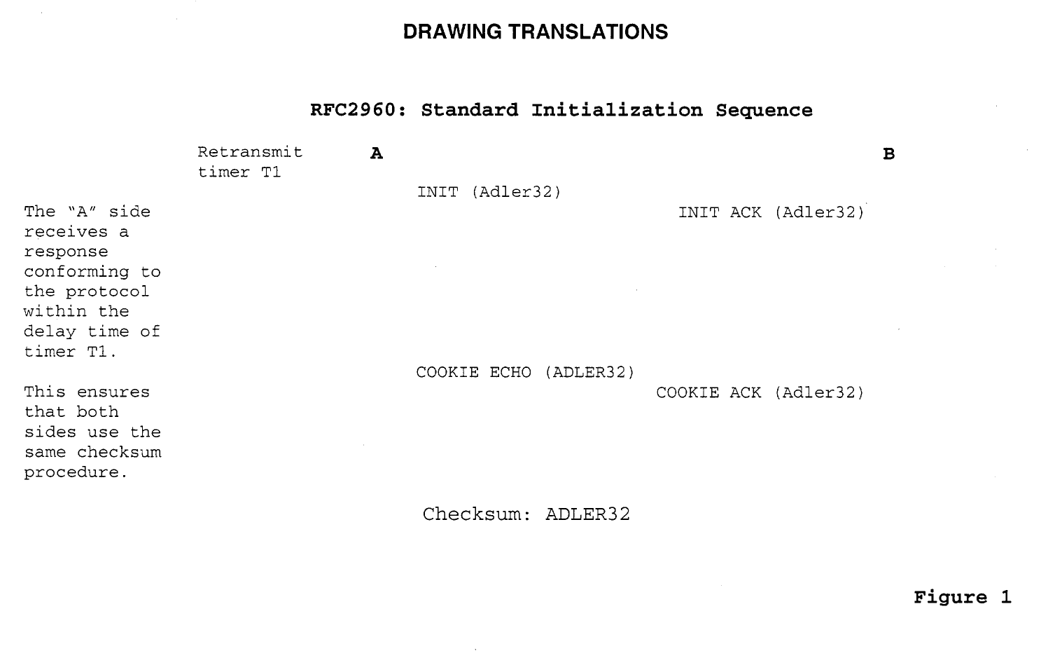

FIG. 1 is a schematic diagram showing the initialization sequence of a connection between two nodes, both of which support only the former ADLER32 checksum algorithm in the conventional way,

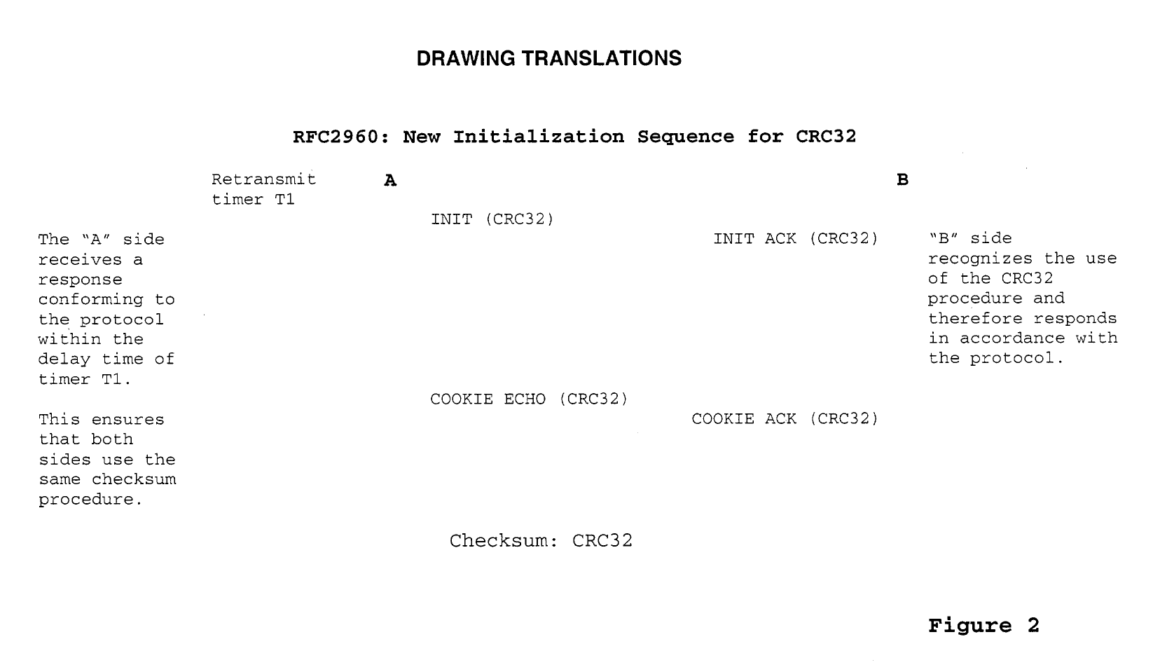

FIG. 2 is a schematic diagram showing the initialization sequence of a connection between two nodes, both of which support only the new CRC32 checksum algorithm in the conventional way,

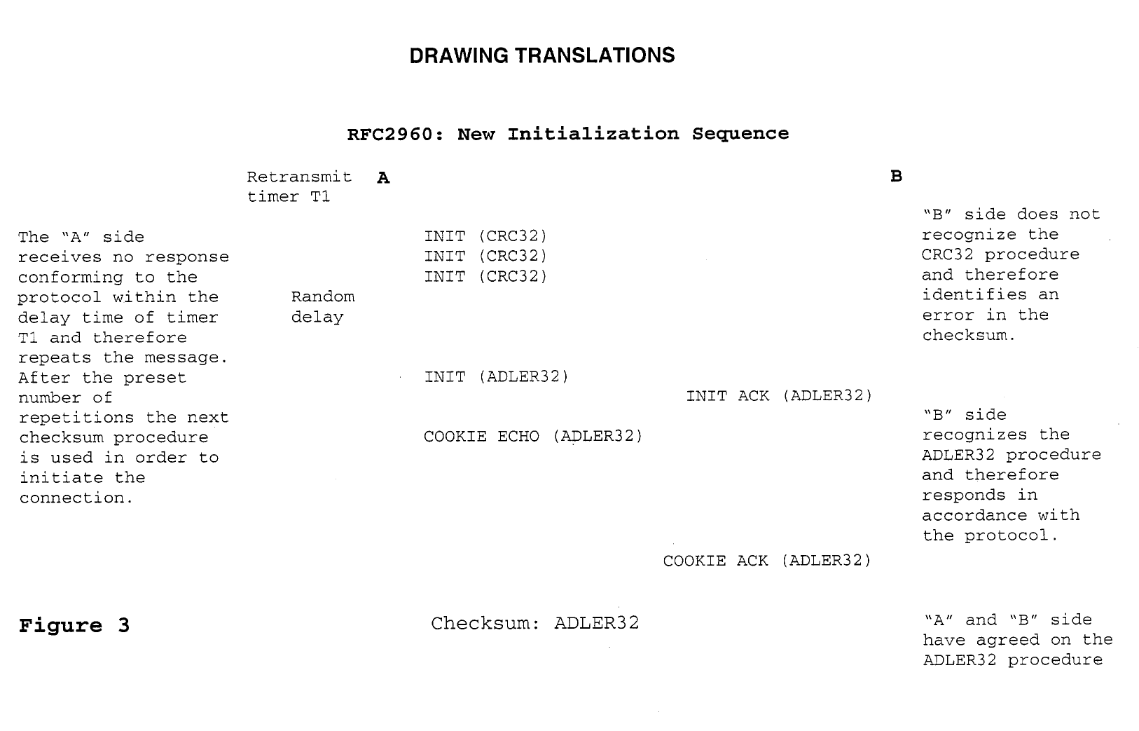

FIG. 3 is a schematic diagram showing the initialization sequence of a connection between a node which uses the method according to the invention and supports two checksum algorithms ADLER32 and CRC32, and a node which supports only the former ADLER32 checksum algorithm in the conventional way, and

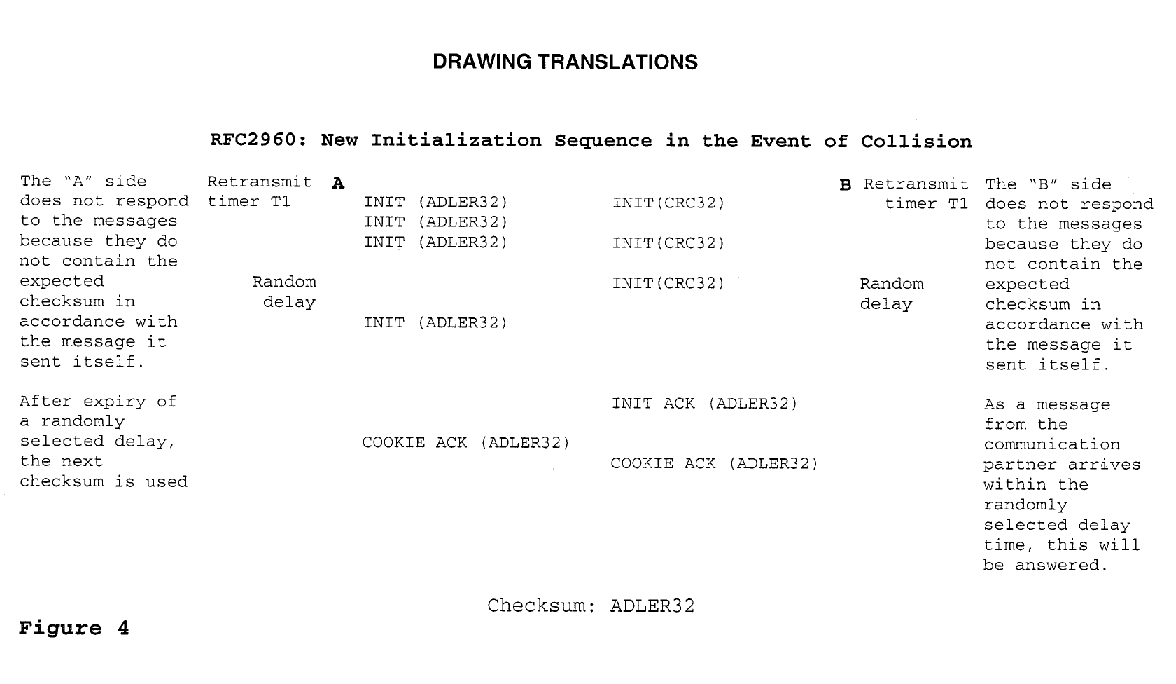

FIG. 4 is a schematic diagram showing the initialization sequence of a connection between two nodes, both of which use the method according to the invention and support two checksum algorithms ADLER32 and CRC32, where one node preferably uses ADLER32 and the other node preferably uses CRC32 and a collision of the connection requests occurs.

The Stream Control Transmission Protocol (SCTP), which is defined in RFC 2960, is considered as the transport protocol for the embodiment example. RFC 2960 describes an algorithm for forming the checksum, known as ADLER32. This algorithm is now being replaced by a new algorithm, referred to as CRC32. As a result of the method according to the invention, it is also possible to introduce a number of new algorithms for forming the checksum to replace the former ADLER32 algorithm. The connection setup using the conventional method, in which both a first network node A and also a second network node B each support only the former ADLER32 algorithm for forming the checksum, is shown in FIG. 1. In the same way, FIG. 2 shows the connection setup using the conventional method, in which both the first network node A and also the second network node B each support only the new CRC32 algorithm for forming the checksum. This means that two endpoints that use different algorithms for forming the checksum cannot communicate with each other.

At this juncture the connection setup for SCTP will be explained briefly with the aid of FIGS. 1 and 2. For the sake of simplicity it is assumed that the connection requests are initiated by the first network node A. Initially, an SCTP packet containing an INIT chunk is sent by the first network node A to the other network node B. The checksum for this SCTP packet is formed using the checksum algorithm implemented in the first network node A, i.e. ADLER32 in FIG. 1 and CRC32 in FIG. 2. The second network node B, which, on account of administrative specifications, uses the same checksum algorithm as the first network node A, recognizes the received SCTP packets as valid or corrupt on the basis of the checksum. Transmission disruptions are indicated by a discrepancy between the checksum formed according to the respective checksum algorithm and the content of the SCTP packet via which the checksum was formed. If such a corrupted SCTP packet is recognized by the second network node B, the packet is discarded by the second network node. If there is no response from the second network node B, the first network node A will repeat the transmission of the corresponding SCTP packet following expiry of a retransmit timer T1. If the SCTP packet received by the second network node B is recognized as valid, which in principle can occur only if no transmission disruptions occur and the same checksum algorithm ADLER32 or CRC32 is used in both network nodes A and B. an SCTP packet containing an INIT ACK chunk is sent by the second network node B. This INIT ACK chunk contains a cookie parameter which is returned by the first network node A to the second network node B in a COOKIE ECHO chunk in a further SCTP packet. The receipt of this COOKIE ECHO chunk is then confirmed by the second network node B by the sending of a COOKIE ACK chunk in an SCTP packet, and the connection between the network nodes A and B is set up using the checksum algorithm ADLER32 (FIG. 1) or CRC32 (FIG. 2) and can be used for transfer of the useful information.

According to the invention, a connection data block in which all connection-specific data of a connection is stored and which is stored in a network node A is extended by a field in which information about the used checksum algorithm can be stored, for example a “checksum_algorithm” field. This always has a value. If a network node A operating with the method according to the invention receives an SCTP packet, a search for the connection data block is initiated. If the connection data block is found, the algorithm specified in the “checksum_algorithm” field is used to verify the packet. Subsequent handling takes place as provided for in the standard. If, however, no connection data block is found, all the available algorithms are used. In the event that only one algorithm recognizes the packet as valid, it is assumed that this algorithm was used; otherwise the packet is discarded. A response that is sent on account of this packet is provided with the checksum of the found algorithm. Also generated is a connection data block whose “checksum_algorithm” field is set to a value representing this algorithm.

For the SCTP protocol, the connection data block is also called the Transmission Control Block (TCB).

If a connection setup using a first checksum method CRC32 is not successful, the initiating first network node A must wait a random period of time (random delay) and can then start a new attempt using a further checksum method ADLER32. This operation is shown in FIG. 3. The second endpoint or network node B has implemented only the ADLER32 checksum algorithm. The first endpoint or network node A has implemented the method according to the invention. Connection setup using the CRC32 checksum algorithm is attempted by the first network node A. Once the network node A recognizes after a number of repetitions (e.g. three repeat transmissions) of the connection setup packet, in each case following expiry of the retransmit timer T1, that the connection setup is not possible using this CRC32 checksum algorithm, the connection setup is initiated using the ADLER32 checksum algorithm, whereupon the second network node B responds as described in the foregoing, and the communication relationship can be set up using the checksum algorithm.

However, SCTP is a peer-to-peer protocol, i.e. both sides can be active simultaneously, and collisions of the initialization messages can occur. A message flow is shown in FIG. 4 to illustrate this. The random delay between the connection attempts of the two endpoints, which, because it is random, is, with a high degree of probability, different for adjacent network nodes A and B. serves to avoid a synchronization (and hence a protracted non-establishment of the connection) that would occur, for example, if

the adjacent network nodes A, B both support the method according to the invention,

the network nodes A, B exhibit different preferred checksum algorithms (in FIG. 4, the ADLER32 algorithm is preferred by the first network node A, and the CRC32 algorithm by the second network node B), and

the switchover to the respective other algorithm were to take place at the same times both in the first network node A and also in the second network node B.

It should be noted that, as indicated at various points already in the foregoing, the invention is applicable to network elements that engage in connections to a plurality of other network elements (“network nodes”) and for network elements that engage in connections only to a single other network element (“endpoint”). As used in the context of this description, the terms “endpoint” and “network node” are synonymous to the extent that an SCTP connection is a point-to-point connection, with the result that for an SCTP connection two (end)points are always involved in a connection, higher-level protocols can, however, communicate unquestionably beyond these SCTP endpoints, and therefore an SCTP endpoint can be a network node for a higher-level protocol.

The present invention is not restricted to the embodiment example. For example, in communication networks which are based on other connection-oriented communication protocols, a plurality of checksum methods can be operated in parallel using the disclosure of the present invention.

1. Method to support a plurality of checksum algorithms in a first network node (A), according to which a communication relationship is established between the first network node (A) and a second network node (B), the initialization of which is effected by the first network node (A), in that in a first step, a first checksum algorithm is selected by the first network node (A),
in a second step, the selected checksum algorithm is signaled to the second network node (B) by the first network node (A),
in a third step, the communication relationship is established using the selected checksum algorithm if the initialization of the communication relationship using the selected checksum algorithm is accepted by the second network node (B) or in the third step, a further checksum algorithm is selected by the first network node (A) if the initialization of the communication relationship using the selected checksum algorithm is rejected or ignored by the second network node (B), in which case the second and third steps are repeated using the newly selected checksum algorithm.

2. Method to support a plurality of checksum algorithms in a first network node (A) for an existing communication relationship between the first network node (A) and a second network node (B), for which a first checksum algorithm is used, according to which
in a first step, a second checksum algorithm is selected by the first network node (A),
in a second step, the selected checksum algorithm is signaled to the second network node (B) by the first network node (A),
in a third step, the selected checksum algorithm for the communication relationship is specified if the use of the selected checksum algorithm is accepted by the second network node (B) or
in the third step, a further checksum algorithm is selected by the first network node (A) if the selected checksum algorithm is rejected or ignored by the second network node (B), the second and third step then being repeated with the newly selected checksum algorithm.

3. Method according to one of the claims 1 or 2, characterized in that
in a fourth step, it is noted in the first network node (A) which checksum algorithm will be used for the communication relationship between the first network node (A) and the second network node (B).

4. Method according to one of the claims 1 to 3, characterized in that
the second step is executed several times under timer control before a further checksum algorithm is selected in the third step.

5. Method according to one of the claims 1 to 4, characterized in that
the repetition of the second and third steps using the newly selected checksum algorithm is delayed by a randomly selected period of time.

6. Method according to one of the claims 1 to 5, characterized in that
the signaling of the selected checksum algorithm by the first network node (A) to the second network node (B) is effected indirectly, in that an initialization message is sent which is coded by means of the checksum algorithm to be signaled.

7. Method according to one of the claims 1 to 6, characterized in that
the Stream Control Transmission Protocol (SCTP) is used as the communication protocol between the first network node (A) and the second network node (B) and
the checksum method used for the communication relationship is noted in a Transmission Control Block of the network node A.

8. Method according to one of the claims 1 to 7, characterized in that,
while maintaining the established communication relationship, a different checksum algorithm is selected by repeating the first to fourth steps accordingly for the new checksum algorithm.

9. Network node (A) in a communication network with means of sending messages, especially initialization messages for initializing communication relationships, and means of receiving messages, said network node exhibiting the following features:
Means of sending the initialization message to a further network node (B) using a first checksum algorithm,
Means of sending the initialization message to the further network node (B) using at least one further checksum algorithm, the further checksum algorithm being used in the event that the initialization using the first checksum algorithm is not successful, and
Means of establishing the communication relationship using the checksum algorithm with which the initialization was successful.

10. Network node (A) in a communication network with means of sending messages and means of receiving messages, said network node exhibiting the following features:
Means of sending and receiving messages using a first checksum algorithm and at least one further checksum algorithm,
Means of determining the checksum algorithm of a received message, and
Means of establishing the communication relationship using the determined checksum algorithm.

11. Network node (A) according to claim 10, characterized in that the network node additionally exhibits the following features:
Means of sending an initialization message to a further network node (B) using the first checksum algorithm,
Means of sending the initialization message to the further network node (B) using the further checksum algorithm, the further checksum algorithm being used in the event that the initialization using the first checksum algorithm is not successful, and
Means of establishing the communication relationship using the checksum algorithm with which the initialization was successful.
